(19) United States
(12) Patent Application Publication
(10) Pub. No.: US 2022/0037904 A1
(43) Pub. Date: Feb. 3, 2022

(54) ENERGY STORAGE POWER SUPPLY, PARALLEL CONTROL DEVICE FOR ENERGY STORAGE POWER SUPPLIES, AND PARALLEL CONTROL METHOD FOR ENERGY STORAGE POWER SUPPLIES

(71) Applicant: SHENZHEN HELLO TECH ENERGY CO LTD, Shenzhen City (CN)

(72) Inventors: Zhongwei SUN, Shenzhen City (CN); Shipeng HONG, Shenzhen City (CN); Peixin ZHANG, Shenzhen City (CN); Hongwei MI, Shenzhen City (CN)

(21) Appl. No.: 17/081,052

(22) Filed: Oct. 27, 2020

(30) Foreign Application Priority Data
Jul. 31, 2020 (CN) 202010760530.1

(51) Int. Cl. H02J 7/00; G08C 17/02

(52) U.S. Cl. CPC H02J 7/0063; G08C 17/02; H02J 7/007

(57) ABSTRACT

Provided are an energy storage power supply, a parallel control device for energy storage power supplies, and a parallel control method for energy storage power supplies. The energy storage power supply includes: a battery module, which is configured to store electric energy or output the electric energy; an inverter module electrically connected to the battery module, where the inverter module is configured to convert a direct current of the battery module into an alternating current; an output module electrically connected to the inverter module, where the output module is configured to output the alternating current after the inverter module is turned on; a communication module wirelessly communicated with another energy storage power supply; and a processor module electrically connected to the inverter module, the output module and the communication module, respectively, where the processor module is configured to control on-off of the output module. In the energy storage power supply, the parallel control device for energy storage power supplies, and the parallel control method for energy storage power supplies provided by embodiments of the present disclosure, when energy storage power supplies are connected in parallel, interference of a power line to a communication signal can be effectively reduced, thereby improving the parallel effect of energy storage power supplies; and the energy storage power supplies do not need to be provided with interfaces for connecting communication lines, thereby reducing the number of interfaces of the energy storage power supplies.

### TECHNICAL FIELD

Embodiments of the present disclosure relate to energy storage power supply technologies, and in particular, to an energy storage power supply, a parallel control device for energy storage power supplies, and a parallel control method for energy storage power supplies.

### BACKGROUND

In many power supply occasions, such as emergency rescue in remote power-short regions, a portable energy storage power supply is usually required for supplying power. Since electric quantity provided by a single energy storage power supply is limited, the single energy storage power supply may not be able to drive a load apparatus with large power. Therefore, a parallel device for energy storage power supplies is required to supply power to an apparatus requiring high-power power supply, so as to ensure the electric energy required for normal operation of the load apparatus.

When connected in parallel, existing energy storage power supplies usually need to be connected with a power line and a communication line. In a case of wire communication, the power line and the communication line are merged into one line. In this case, the power line will interfere with a communication signal in the communication line, thus affecting a parallel effect and even damaging the energy storage power supplies.

### SUMMARY

Embodiments of the present disclosure provide an energy storage power supply, a parallel control device for energy storage power supplies, and a parallel control method for energy storage power supplies, when energy storage power supplies are connected in parallel, interference of a power line to a communication signal can be effectively reduced, thereby improving the parallel effect of energy storage power supplies; and the energy storage power supplies do not need to be provided with interfaces for connecting communication lines, thereby reducing the number of interfaces of the energy storage power supplies.

In a first aspect, an embodiment of the present disclosure provides an energy storage power supply including a battery module, an inverter module, an output module, a communication module, and a processor module.

The battery module is configured to store electric energy or output the electric energy.

The inverter module is electrically connected to the battery module, and is configured to convert a direct current of the battery module into an alternating current.

The output module is electrically connected to the inverter module, and is configured to output the alternating current after the inverter module is turned on.

The communication module is wirelessly communicated with another energy storage power supply.

The processor module is electrically connected to the inverter module, the output module and the communication module, respectively, and is configured to control on-off of the output module.

Optionally, the energy storage power supply further includes a switching module, the switching module is connected between the inverter module and the output module, the processor module is connected to the switching module, and the switching module is configured to control on-off of a wiring between the inverter module and the output module.

Optionally, a wireless communication mode of the communication module is WiFi, Bluetooth or Zigbee.

In a second aspect, an embodiment of the present disclosure further provides a parallel control device for energy storage power supplies. The device includes at least two energy storage power supplies according to the first aspect and a parallel module connected to the at least two energy storage power supplies, and the parallel module configured to communicate with output modules of the at least two energy storage power supplies.

Optionally, a communication module of each of the at least two energy storage power supplies is configured to transmit or receive a synchronizing signal, and the synchronizing signal includes a signal of voltage and phase of an energy storage power supply.

Optionally, one of the at least two energy storage power supplies serves as a master, other energy storage power supplies of the at least two energy storage power supplies serve as slaves, a processor module of the master is configured to transmit a synchronizing signal to at least one slave through a communication module, and a processor module of the at least one slave is configured to control an inverter module of the least one slave to adjust a voltage and a phase of an alternating current output by the inverter module until the voltage and the phase match the synchronizing signal.

Optionally, the processor module of the at least one slave is configured to turn on an output module of the at least one slave after controlling the invertor module to adjust the voltage and the phase of the alternating current to match the synchronizing signal.

In a third aspect, an embodiment of the present disclosure further provides a parallel control method for energy storage power supplies. The parallel control method for energy storage power supplies is implemented by a processor module of an energy storage power supply according to the first aspect, and the method includes steps described below.

Whether a synchronizing signal is received is detected after the energy storage power supply is started.

In response to detecting that no synchronizing signal is received, the synchronizing signal is transmitted through a communication module.

In response to detecting that the synchronizing signal is received, a voltage and a phase output by an inverter module are adjusted until the voltage and the phase match the synchronizing signal.

Optionally, the energy storage power supply further includes a switching module, the switching module is connected between the inverter module and an output module, and a processor module is connected to the switching module.

After adjusting the voltage and the phase output by the inverter module to match the synchronizing signal, the parallel control method for energy storage power supplies further includes a step described below.

The switching module is controlled to be on such that a wiring between the inverter module and the output module is turned on.

Optionally, after controlling the switching module to be on, the parallel control method for energy storage power supplies further includes a step described below.

The voltage and the phase output by the inverter module are adjusted in real time according to the synchronizing signal.

Optionally, after adjusting the voltage and the phase output by the inverter module to match the synchronizing signal, the parallel control method for energy storage power supplies further includes a step described below.

In response to a load of an apparatus electrically connected to the energy storage power supply being less than a preset threshold value, the communication module is controlled to be off such that a parallel state of the energy storage power supplies becomes a parallel capacity state.

In the energy storage power supply, the parallel control device for energy storage power supplies, and the parallel control method for energy storage power supplies provided by embodiments of the present disclosure, the energy storage power supply includes the battery module, the inverter module, the output module, the communication module, and the processor module. The inverter module is electrically connected to the battery module, the output module is electrically connected to the inverter module, the communication module is wirelessly communicated with another energy storage power supply, and the processor module is electrically connected to the inverter module, the output module and the communication module, respectively, and is configured to control on-off of the output module. Compared with the existing parallel control device for energy storage power supplies, in the energy storage power supply, the parallel control device for energy storage power supplies, and the parallel control method for energy storage power supplies provided by embodiments of the present disclosure, the communication module is wirelessly communicated with another energy storage power supply, and the processor module is electrically connected to the inverter module, the output module and the communication module, respectively, and is configured to control on-off of the output module. Compared with the existing energy storage power supply, the energy storage power supply provided by the embodiments of the present disclosure can control an energy transmission state by controlling the on-off of the output module through the processor module. For example, when the energy storage power supply supplies power separately or in parallel, the processor module can control the output module to be on so as to ensure that the energy storage power supply outputs electric energy. Moreover, the communication module is wirelessly connected to another energy storage power supply, when energy storage power supplies are connected in parallel, interference of a power line to a communication signal can be effectively reduced, thereby improving the parallel effect of the energy storage power supplies. In addition, the energy storage power supplies do not need to be provided with interfaces for connecting communication lines, thereby reducing the number of interfaces of the energy storage power supplies, and thus the power cord can be made smaller accordingly.

### BRIEF DESCRIPTION OF DRAWINGS

FIG. 1 is a block diagram illustrating an energy storage power supply according to embodiment one of the present disclosure;

FIG. 2 is a block diagram illustrating a parallel control device for energy storage power supplies according to embodiment two of the present disclosure;

FIG. 3 is a flowchart illustrating a parallel control method for energy storage power supplies according to embodiment three of the present disclosure; and

FIG. 4 is a flowchart illustrating another parallel control method for energy storage power supplies according to embodiment three of the present disclosure.

### DETAILED DESCRIPTION

Hereinafter the present disclosure is further described in detail in conjunction with the drawings and embodiments. It is to be understood that the embodiments set forth below are intended to illustrate and not to limit the present disclosure. Additionally, it is to be noted that for ease of description, only part, not all, of the structures related to the present disclosure are illustrated in the drawings.

### Embodiment One

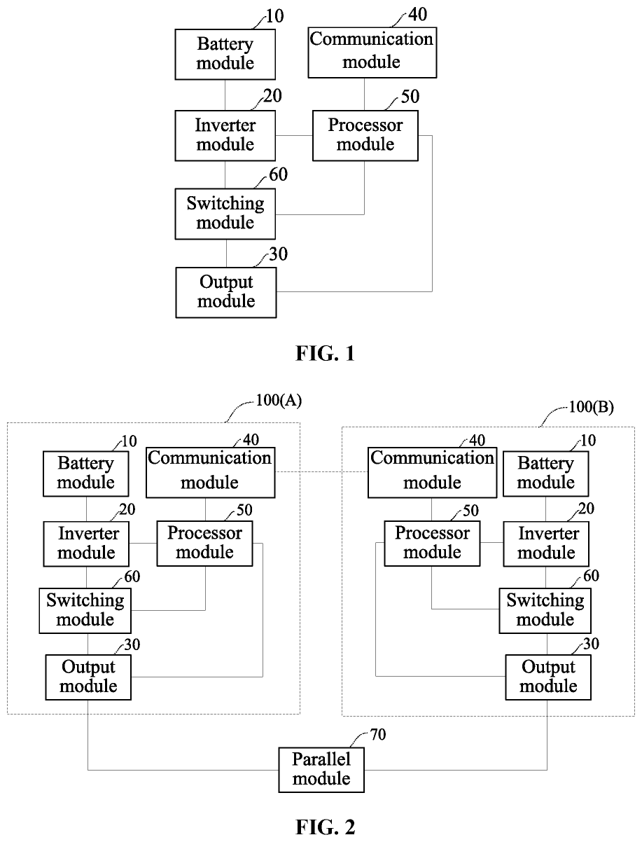

FIG. 1 is a block diagram illustrating an energy storage power supply according to embodiment one of the present disclosure. This embodiment may be applied to cases of supplying power to a power supply apparatus or the like. The energy storage power supply includes a battery module 10, an inverter module 20, an output module 30, a communication module 40 and a processor module 50.

The battery module 10 is configured to store electric energy or output the electric energy. The inverter module 20 is electrically connected to the battery module 10, and is configured to convert a direct current of the battery module 10 into an alternating current. The output module 30 is electrically connected to the inverter module 20, and is configured to output the alternating current after the inverter module 20 is turned on. The communication module 40 is wirelessly communicated with another energy storage power supply. The processor module 50 is electrically connected to the inverter module 20, the output module 30 and the communication module 40, respectively, and is configured to control on-off of the output module 30.

Particularly, when the energy storage power supply is required to supply power to an apparatus, the energy storage power supply is started, the inverter module 20 of the energy storage power supply converts the direct current of the battery module 10 into the alternating current, and the processor module 50 controls the output module 30 to be on such that the alternating current converted by the inverter module 20 is output through the output module 30, thereby enabling the energy storage power supply to output electric energy so as to supply power to the apparatus. When the power supplying of the energy storage power supply is completed or the apparatus does not need to be supplied with power, the processor module 50 can control the output module 30 to be off. When the energy storage power supply supplies power separately or in parallel, the processor module 50 can control the output module 30 to be on so as to ensure that the power supply outputs the electric energy. For example, if a power of a load is large and the electric energy output by one energy storage power supply cannot satisfy the electric energy required by the load, at least two energy storage power supplies may be connected in parallel, and the communication module 40 of this energy storage power supply should be wirelessly communicated with a communication module of another energy storage power supply, such that the at least two energy storage power supplies can output electric energy in parallel through a wireless communication mode, thereby increasing the power supplied to the apparatus. In particular, two energy storage power supplies being connected in parallel is described as an example. The two energy storage power supplies may be connected in parallel through power lines, the two energy storage power supplies work in parallel after started, and the two energy storage power supplies have two pairing modes. In mode one, after the two energy storage power supplies are started, the two energy storage power supplies are automatically paired, a first started energy storage power supply of the two energy storage power supplies may serve as a master, and a second started energy storage power supply serves as a slave. In mode two, after the two energy storage power supplies are started, the communication module 40 automatically performs pairing, and automatically selects one of the two energy storage power supplies as the master and the other energy storage power supply as the slave. The mode one for pairing is fast, but when there are multiple energy storage power supplies, a case of mispairing will occur. The mode two for pairing is tedious, but relatively safe. After two parallel energy storage power supplies are paired, the processor module 50 of the energy storage power supply serving as the master controls the output module 30 of the master to be on, and transmits a wireless communication signal to the communication module 40 of the energy storage power supply serving as the slave through the communication module 40 of the master. The processor module 50 of the energy storage power supply serving as the slave receives the wireless communication signal through the communication module 40 of the slave, and controls the output module 30 of the slave to be on, thus ensuring that both the two energy storage power supplies output electric energy and achieving the purpose that the two energy storage power supplies are connected in parallel to supply power to the load. After the power supplying of the two parallel energy storage power supplies is completed, the processor module 50 of the master can control the output module 30 of the master to be turned off, and the processor module 50 of the slave can control the output module 30 of the slave to be turned off. Moreover, the communication line can be saved with the wireless communication mode. When the energy storage power supplies perform wire communication through the communication line, the communication line and the power line are typically merged into one line, causing the signal of the wire communication being interfered by the power line. Whereas, the wireless communication is performed through the communication module 40, such that the interference of the power line to the communication signal can be reduced, and the energy storage power supplies do not need to be provided with interfaces for connecting communication lines, thereby reducing the number of interfaces of the energy storage power supplies, and the power line can be correspondingly smaller.

The energy storage power supply provided by this embodiment includes the battery module, the inverter module, the output module, the communication module, and the processor module. The inverter module is electrically connected to the battery module, the output module is electrically connected to the inverter module, the communication module is wirelessly communicated with another energy storage power supply, and the processor module is electrically connected to the inverter module, the output module and the communication module, respectively, and is configured to control on-off of the output module. Compared with the existing energy storage power supply, the energy storage power supply provided by the embodiment of the present disclosure can control an energy transmission state of the energy storage power supply by controlling the on-off of the output module through the processor module. For example, when the energy storage power supply supplies power separately or in parallel, the processor module can control the output module to be on so as to ensure that the energy storage power supply outputs electric energy. Moreover, when the energy storage power supplies are connected in parallel, the communication module of one energy storage power supply is wirelessly communicated with another energy storage power supply, such that interference of the power line to the communication signal can be effectively reduced, thereby improving the parallel effect of the energy storage power supplies. In addition, the energy storage power supply does not need to be provided with an interface for connecting the communication line, thus reducing the number of interfaces of the energy storage power supply, and the power line can be correspondingly smaller.

Optionally, the energy storage power supply further includes a switching module 60, the switching module 60 is connected between the inverter module 20 and the output module 30, the processor module 50 is connected to the switching module 60, and the switching module 60 is configured to control on-off of a wiring between the inverter module 20 and the output module 30.

Particularly, when the energy storage power supply supplying power to the apparatus and being started, the processor module 50 controls the wiring between the inverter module 20 and the output module 30 to be conductive through the switching module 60, such that the alternating current converted by the inverter module 20 is output through the output module 30, thereby enabling the energy storage power supply to output electric energy so as to supply power to the apparatus. When the power supplying of the energy storage power supply is completed or the apparatus does not need to be supplied with power, the processor module 50 can control the wiring between the inverter module 20 and the output module 30 to be turned off through the switching module 60, so as to prevent power loss of the energy storage power supply caused by power output. When the energy storage power supply supplies power separately or in parallel, the processor module 50 can control the wiring between the inverter module 20 and the output module 30 to be conductive through the switching module 60 so as to ensure that the power supply outputs the electric energy. For example, when two energy storage power supplies are connected in parallel to supply power to the load, the two energy storage power supplies may be connected in parallel through the power line, and the two energy storage power supplies work in parallel after started. A first started energy storage power supply of the two energy storage power supplies serves as the master, and the second started energy storage power supply serves as the slave. Alternatively, after the two energy storage power supplies are started, the communication module automatically performs pairing, and automatically selects one of the two energy storage power supplies as the master and the other energy storage power supply as the slave. After the two parallel energy storage power supplies are paired, the processor module 50 of the energy storage power supply serving as the master controls, through the switching module 60 of the master, a wiring between the inverter module 20 of the master and the output module 30 of the master to be conductive, and transmits a wireless communication signal to the communication module 40 of the energy storage power supply serving as the slave through the communication module 40 of the master. The processor module 50 of the energy storage power supply serving as the slave receives the wireless communication signal through the communication module 40 of the slave, and controls a wiring between the inverter module 20 of the slave and the output module 30 of the slave to be conductive, thus ensuring that both the two energy storage power supplies output electric energy and achieving the purpose that the two energy storage power supplies are connected in parallel to supply power to the load. After the power supplying of the two parallel energy storage power supplies is completed, the processor module 50 of the master can control, through the switching module 60 of the master, the wiring between the inverter module 20 of the master and the output module 30 of the master to be turned off, and the processor module 50 of the slave can control, through the switching module 60 of the slave, the wiring between the inverter module 20 of the slave and the output module 30 of the slave to be turned off.

Optionally, a wireless communication mode of the communication module 40 is WiFi, bluetooth or Zigbee.

Particularly, the bluetooth communication can be used when two energy storage power supplies are connected in parallel, the WiFi communication can be used when more than two energy storage power supplies are connected in parallel, and the Zigbee communication can be used when a distance between each of energy storage power supplies connected in parallel is small.

It is to be noted that the above-mentioned wireless communication mode of the communication module 40 is only exemplarily description, the wireless communication mode of the communication module 40 may be set according to the actual situation, and is not limited herein.

### Embodiment Two

FIG. 2 is a block diagram illustrating a parallel control device for energy storage power supplies according to embodiment two of the present disclosure. This embodiment may be applied to cases of supplying power to a power supply apparatus or the like. Referring to FIG. 2, the parallel control device for energy storage power supplies includes at least two energy storage power supplies 100 according to embodiment one and includes a parallel module 70 connected to the at least two energy storage power supplies 100, and the parallel module 70 is configured to communicate with output modules 30 of the at least two energy storage power supplies 100.

The parallel module 70 may include a power line, and the output modules 30 of the at least two energy storage power supplies 100 are communicated through the parallel module 70 to achieve the parallel connection of the at least two energy storage power supplies 100. When N energy storage power supplies 100 are connected in parallel, total output power of the N energy storage power supplies 100 is N times of output power of one energy storage power supply, and a total capacity is also N times of a capacity of one energy storage power supply 100. For example, output power of a single energy storage power supply 100 with a capacity of 1000 Wh is 1000 W, and a total capacity increases to 3000 Wh and total output power increases to 3000 W after three energy storage power supplies are connected in parallel. Thus, the capacity can be multiplied and the output power can also be multiplied. When the energy storage power supplies 100 work in parallel, a load apparatus with higher power can be driven, and service time can be enhanced at the same time. When the energy storage power supplies 100 do not need to be connected in parallel, the parallel control device for energy storage power supplies can be disassembled, and each energy storage power supply 100 for the parallel control device for energy storage power supplies can work separately, which is flexible and convenient, and can satisfy various requirements.

The parallel control device for energy storage power supplies provided by this embodiment includes at least two energy storage power supplies of embodiment one and includes the parallel module connected to the at least two energy storage power supplies. The parallel module is communicated with the output modules of the at least two energy storage power supplies. The communication module of one energy storage power supply of the at least two energy storage power supplies is wirelessly communicated with other energy storage power supplies, such that interference of the parallel module (such as a power line) in the parallel control device for energy storage power supplies to a communication signal can be effectively reduced, thereby improving the parallel effect of the energy storage power supplies. In addition, each energy storage power supply in the parallel control device for energy storage power supplies does not need to be provided with an interface connecting the communication line, thus reducing the number of interfaces of the energy storage power supply, and the power line can be correspondingly smaller. Meanwhile, compared with the capacity of a single energy storage power supply, the total capacity of the parallel control device for energy storage power supplies is multiplied, and the output power is also multiplied. Therefore, the parallel control device for energy storage power supplies can drive the load apparatus with larger power, and increases the service time at the same time. When the energy storage power supplies do not need to be connected in parallel, the parallel control device for energy storage power supplies can be disassembled, and each energy storage power supply in the parallel control device for energy storage power supplies can be used separately, which is flexible and convenient, and can satisfy various requirements.

Optionally, a communication module 40 is configured to transmit or receive a synchronizing signal, and the synchronizing signal includes a signal of voltage and phase of an energy storage power supply 100.

Particularly, if the synchronizing signal is received by the communication module 40, it indicates that one of the at least two energy storage power supplies 100 connected in parallel transmits the synchronizing signal, and the processor module 50 receiving the synchronizing signal through the communication module 40 can adjust the voltage and the phase of the alternating current output by the inverter module 20 according to the synchronizing signal; and if no synchronizing signal is received by the communication module 40, and the communication module 40 transmits synchronizing signal outward, it indicates that the alternating current output by inverter modules 20 of other energy storage power supplies needs to be adjusted according to the synchronizing signal.

Optionally, one of the at least two energy storage power supplies 100 serves as a master, and other energy storage power supplies 100 serve as slaves. The processor module 50 of the master transmits the synchronizing signal to at least one slave through the communication module 40 of the master. The processor module 50 of the at least one slave controls the inverter module 20 of the at least one slave to adjust, according to the synchronizing signal received by the communication module 40, the voltage and the phase of the alternating current output by the inverter module until the voltage and the phase match the synchronizing signal.

Particularly, each of the energy storage power supplies 100 connected in parallel in the parallel control device for energy storage power supplies may be determined as the master or the slave according to a starting time. For example, an energy storage power supply 100 started early serves as the master, and other energy storage power supplies 100 serve as slaves. The processor module 50 of the master transmits the synchronizing signal to at least one slave through the communication module 40, the processor module 50 of the slave controls, based on the synchronizing signal received by the communication module 40, the inverter module 20 to adjust the voltage and the phase of the alternating current until t the voltage and the phase match the synchronizing signal such that the voltage and the phase of the alternating current output by the inverter module 20 of the slave correspond to the voltage and the phase of the alternating current output by the inverter module 20 of the master.

Optionally, after the processor module 50 of the at least one slave controlling the inverter module 20 to adjust the voltage and the phase of the alternating current to match the synchronizing signal, the output module 30 of the at least one slave is controlled to be conductive.

The processor module 50 of the slave controls the inverter module 20 to adjust the voltage and the phase of the alternating current in real time according to the received synchronizing signal, and when the adjusted voltage and phase match the synchronizing signal, the output module 30 of the slave is controlled to be conductive such that the alternating current whose voltage and phase match the synchronizing signal is output through the output module 30. In this way, the total output power of the master and the slave is multiplied compared with the output power of a single energy storage power supply, and the purpose of driving a load apparatus with higher power is achieved.

For example, the parallel control device for energy storage power supplies includes two energy storage power supplies 100 of embodiment one and the parallel module 70 connected to the two energy storage power supplies 100. As shown in FIG. 2, two energy storage power supplies A and B are connected in parallel through the parallel module 70 so as to supply power to the load. The two energy storage power supplies A and B work in parallel after started, and there are two paring modes for the two energy storage power supplies. In mode one, after the two energy storage power supplies A and B are started, the two energy storage power supplies A and B are automatically paired, a first started energy storage power supply of the two energy storage power supplies A and B serves as a master, and a second started energy storage power supply serves as a slave. In mode two, after the two energy storage power supplies A and B are started, the communication module 40 automatically performs pairing, and automatically selects one of the two energy storage power supplies as the master and the other energy storage power supply as the slave. The pairing one is fast, but when there are multiple energy storage power supplies 100, a case of mispairing will occur. The pairing mode two is tedious, but relatively safe. If the energy storage power supply A starts at first and the energy storage power supply B starts later, the energy storage power supply A serves as the master, and the energy storage power supply B serves as the slave. The processor module 50 of the energy storage power supply A serving as the master controls the output module 30 of the master to be conductive, and transmits a wireless communication signal to the communication module 40 of the energy storage power supply B serving as the slave through the communication module 40 of the master. The wireless communication signal may be the synchronizing signal, and the synchronizing signal includes the voltage signal and phase signal of the energy storage power supply A. The processor module 50 of the energy storage power supply B serving as the slave receives the synchronizing signal through the communication module 40 of the slave, and adjusts, according to the synchronizing signal, the voltage and the phase output by the inverter module 20 of the slave to match the synchronizing signal, such that the voltage and the phase of the alternating current output by the inverter module 20 of the slave correspond to the voltage and the phase of the alternating current output by the inverter module 20 of the master. After the voltage and the phase output by the inverter module 20 of the slave being adjusted to match the synchronizing signal, the processor module 50 of the slave controls the output module 30 of the slave to be conductive. In this way, the total output power of the master and the slave is multiplied compared with the output power of a single energy storage power supply, and the purpose of driving a load apparatus with larger power is achieved.

### Embodiment Three

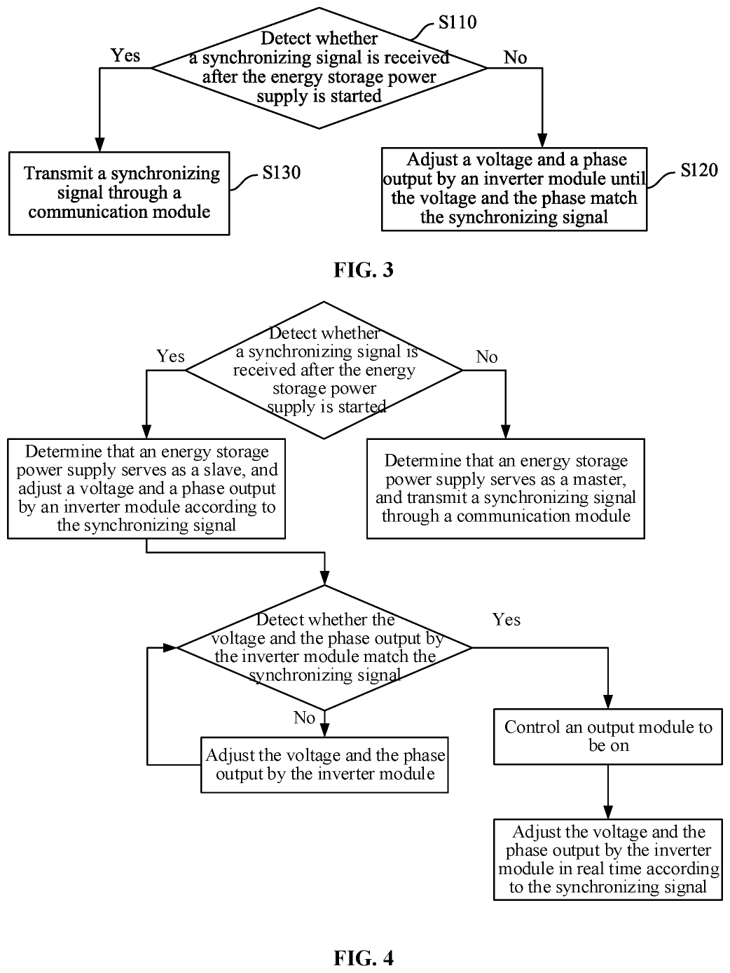

FIG. 3 is a flowchart illustrating a parallel control method for energy storage power supplies according to embodiment three of the present disclosure. This embodiment may be applied to cases of supplying power to a power supply apparatus or the like. The parallel control method for energy storage power supplies is implemented by the processor module of the energy storage power supply of any one of the above-mentioned embodiments, and includes steps described below.

In step 110, whether a synchronizing signal is received is detected after the energy storage power supply is started.

The synchronizing signal includes a voltage signal and a phase signal of the energy storage power supply, and wireless communication is performed between parallel energy storage power supplies through communication modules. Referring to FIG. 2, an energy storage power supply A is described as an example. After the energy storage power supply A is started, a processor module 50 of the energy storage power supply A receives or transmits a synchronizing signal through a communication module 40 of the energy storage power supply A, and the processor module 50 of the energy storage power supply A can detect whether the synchronizing signal is received according to an interface set by the processor module 50 itself that is electrically connected to the communication module 40 of the energy storage power supply A, so as to perform corresponding control according to a detection result.

In step 120, in response to detecting that no synchronizing signal is received, a synchronizing signal is transmitted through the communication module.

Particularly, after detecting that no synchronizing signal is received, the processor module generates a synchronizing signal including the voltage signal and phase signal of the energy storage power supply, and transmits the synchronizing signal through the communication module; and other energy storage power supplies can receive the synchronizing signal through wireless communication, such that processor modules of other energy storage power supplies can adjust the voltage and the phase output by the inverter modules thereof according to the synchronizing signal.

In step 130, in response to detecting that the synchronizing signal is received, the voltage and the phase output by the inverter module are adjusted until the voltage and the phase match the synchronizing signal.

Particularly, if it is detected that a synchronizing signal is received, it means that one of parallel energy storage power supplies transmits the synchronizing signal, and the processor module of the present energy storage power supply needs to adjust the voltage and the phase output by the inverter module until the voltage and the phase match the synchronizing signal, such that the voltage and the phase output by the inverter module can correspond to the voltage and the phase output by the inverter module of the energy storage power supply transmitting the synchronizing signal. In this way, the total output power of the parallel energy storage power supplies is multiplied, and thereby a load apparatus with larger power can be driven when the energy storage power supplies work in parallel.

Exemplarily, the two energy storage power supplies A and B connected in parallel shown in FIG. 2 are described as an example. The two energy storage power supplies A and B are connected in parallel to supply power to the load after started, and there are two pairing modes for the two energy storage power supplies A and B. In mode one, after the two energy storage power supplies A and B are started, the two energy storage power supplies A and B are automatically paired, a first started energy storage power supply of the two energy storage power supplies A and B may serve as a master, and a second started energy storage power supply serves as a slave. In mode two, after the two energy storage power supplies A and B are started, the communication module 40 automatically performs pairing, and automatically selects one of the two energy storage power supplies as the master and the other energy storage power supply as the slave. The pairing mode one is fast, but when there are multiple energy storage power supplies 100, a case of mispairing will occur. The pairing mode two is tedious, but relatively safe. The energy storage power supply A is described as an example. After the energy storage power supply A is started, the processor module 50 of the energy storage power supply A detects whether the synchronizing signal is received. If it is detected that no synchronizing signal is received, the energy storage power supply A serves as the master, and the processor module 50 of the energy storage power supply A serving as the master transmits the synchronizing signal through the communication module 40 of the energy storage power supply A. The synchronizing signal includes the voltage signal and the phase signal of the energy storage power supply A. The processor module 50 of the energy storage power supply B receives the synchronizing signal through the communication module 40 of the energy storage power supply B, and adjusts, according to the synchronizing signal, the voltage and the phase output by the inverter module 20 of the energy storage power supply B to match the synchronizing signal, such that the voltage and the phase of the alternating current output by the inverter module 20 of the energy storage power supply B serving as the slave can correspond to the voltage and the phase of the alternating current output by the inverter module 20 of the energy storage power supply A serving as the master. If the processor module 50 of the energy storage power supply A detects that a synchronizing signal is received, then the energy storage power supply A serves as the slave. The processor module 50 of the energy storage power supply A serving as the slave adjusts the voltage and the phase output by the inverter module 20 of the energy storage power supply A to match the synchronizing signal, such that the voltage and the phase of the alternating current output by the inverter module 20 of the energy storage power supply A serving as the slave can correspond to the voltage and the phase of the alternating current output by the inverter module 20 of the energy storage power supply B serving as the master, so as to ensure that the output power of two energy storage power supplies is doubled compared with the output power of a single energy storage power supply, thereby achieving the purpose of driving the load apparatus with larger power.

Moreover, after the voltage and the phase output by the inverter module are adjusted to match the synchronizing signal, in response to a load of an apparatus electrically connected to the energy storage power supply being less than a preset threshold value, the communication module is controlled to be turned off such that a parallel state of the energy storage power supplies becomes a parallel capacity state. For example, the preset threshold value is a load value of the apparatus whose power requirement can be satisfied by the electric energy provided by one energy storage power supply. If the load of the apparatus electrically connected to the energy storage power supply is less than the preset threshold value, the communication module can be controlled to be turned off, such that the parallel state of the energy storage power supply becomes the parallel capacity state, thereby reducing loss of the electric energy of the energy storage power supplies.

In addition, the energy storage power supply further includes a switching module connected between the inverter module and the output module, and the processor module is connected to the switching module. After the voltage and the phase output by the inverter module being adjusted to match the synchronizing signal, the processor module of the energy storage power supply may further control the switching module to be conductive, a wiring between the inverter module and the output module is conductive, and the voltage and the phase output by the inverter module are adjusted in real time according to the synchronizing signal. If the processor module adjusts the voltage and the phase output by the inverter module to match the synchronizing signal, the switching module can be controlled to be conductive such that the alternating current whose voltage and phase match the synchronizing signal is output through the output module, thereby enabling the energy storage power supply to output the alternating current so as to supply power to the apparatus.

In a specific implementation, FIG. 4 is a flowchart illustrating another parallel control method for energy storage power supplies according to embodiment three of the present disclosure. The parallel control method for energy storage power supplies is implemented by the processor module of any one of the above-mentioned energy storage power supplies, and includes steps described below.

In step one, whether a synchronizing signal is received is detected after the energy storage power supply is started; if yes, step two is implemented; and if not, step three is implemented.

The synchronizing signal includes a voltage signal and a phase signal of the energy storage power supply, and wireless communication is performed between parallel energy storage power supplies through communication modules. A processor module receives or transmits the synchronizing signal through a communication module, and the processor module can detect whether the synchronizing signal is received according to an interface set by the processor module itself that is electrically connected to the communication module, so as to perform corresponding control according to a detection result.

In step two, an energy storage power supply receiving the synchronizing signal is determined to be a slave, and the voltage and the phase output by the inverter module of the energy storage power supply are adjusted according to the synchronizing signal.

Particularly, if it is detected that the synchronizing signal is received, it means that one of parallel energy storage power supplies transmits the synchronizing signal, that is, the energy storage power supply transmitting the synchronizing signal serves as a master. At this time, the energy storage power supply receiving the synchronizing signal serves as the slave, and adjusts, according to the synchronizing signal, the voltage and the phase output by the inverter module so as to make the voltage and the phase output by the inverter module to match the synchronizing signal. In addition, after step two is implemented, step four is implemented.

In step three, the energy storage power supply not receiving the synchronizing signal is determined to be a master, and transmits a synchronizing signal through the communication module.

Particularly, if it is detected that no synchronizing signal is received, the energy storage power supply is determined to be the master, and a synchronizing signal is transmitted through the communication module; and other energy storage power supplies can receive the synchronizing signal through their own communication modules so as to adjust the voltage and the phase output by the inverter modules thereof according to the synchronizing signal.

In step four, whether the voltage and the phase output by the inverter module match the synchronizing signal is detected, if yes, step five is implemented; and if no, step seven is implemented.

In step five, the output module is controlled to be conductive.

In step six, the voltage and the phase output by the inverter module are adjusted in real time according to the synchronizing signal.

In step seven, adjusting the voltage and the phase output by the inverter module, and returning to step four.

The parallel control method for energy storage power supplies provided by this embodiment and the energy storage power supply and the parallel control device for energy storage power supplies provided by any one of embodiments of the present disclosure belong to the same inventive concept and have the same beneficial effects. For technical details not described in detail in this embodiment, reference may be made to the energy storage power supply and the parallel control device for energy storage power supplies provided by any one of embodiments of the present disclosure.

It is to be noted that the above are merely preferred embodiments of the present disclosure and the technical principles used therein. It will be understood by those skilled in the art that the present disclosure is not limited to the specific embodiments described herein. Those skilled in the art can make various apparent modifications, adaptations, combinations and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. An energy storage power supply, comprising:
a battery module, which is configured to store electric energy or output the electric energy;
an inverter module electrically connected to the battery module, wherein the inverter module is configured to convert a direct current of the battery module into an alternating current;
an output module electrically connected to the inverter module, wherein the output module is configured to output the alternating current after the inverter module is turned on;
a communication module wirelessly communicated with another energy storage power supply; and
a processor module electrically connected to the inverter module, the output module and the communication module, respectively, wherein the processor module is configured to control on-off of the output module.

2. The energy storage power supply of claim 1, further comprising a switching module, wherein the switching module is connected between the inverter module and the output module, the processor module is connected to the switching module, and the switching module is configured to control on-off of a wiring between the inverter module and the output module.

3. The energy storage power supply of claim 1, wherein a wireless communication mode of the communication module is WiFi, Bluetooth or Zigbee.

4. A parallel control device for energy storage power supplies, comprising: at least two energy storage power supplies of claim 1, and a parallel module connected to the at least two energy storage power supplies, wherein the parallel module is configured to communicate with output modules of the at least two energy storage power supplies.

5. The parallel control device for energy storage power supplies of claim 4, wherein a communication module of each of the at least two energy storage power supplies is configured to transmit or receive a synchronizing signal, and the synchronizing signal comprises a signal of voltage and phase of an energy storage power supply.

6. The parallel control device for energy storage power supplies of claim 4, wherein one of the at least two energy storage power supplies serves as a master, other energy storage power supplies of the at least two energy storage power supplies serve as slaves, a processor module of the master is configured to transmit a synchronizing signal to at least one slave through a communication module, and a processor module of the at least one slave is configured to control an inverter module of the least one slave to adjust, based on the synchronizing signal received by a communication module of the at least one slave, a voltage and a phase of an alternating current output by the inverter module until the voltage and the phase match the synchronizing signal.

7. The parallel control device for energy storage power supplies of claim 6, wherein the processor module of the at least one slave is configured to turn on an output module of the at least one slave after controlling the invertor module to adjust the voltage and the phase of the alternating current to match the synchronizing signal.

8. A parallel control method for energy storage power supplies, wherein the parallel control method for energy storage power supplies is implemented by a processor module of an energy storage power supply of claim 1, and comprises:
detecting whether a synchronizing signal is received after the energy storage power supply is started;
in response to detecting that no synchronizing signal is received, transmitting a synchronizing signal through a communication module; and
in response to detecting that the synchronizing signal is received, adjusting a voltage and a phase output by an inverter module until the voltage and the phase match the synchronizing signal.

9. The parallel control method for energy storage power supply of claim 8, wherein the energy storage power supply further comprises a switching module, the switching module is connected between the inverter module and an output module, and a processor module is connected to the switching module; and
after adjusting the voltage and the phase output by the inverter module to match the synchronizing signal, the parallel control method for energy storage power supply further comprises:
controlling the switching module to be on such that a wiring between the inverter module and the output module is turned on.

10. The parallel control method for energy storage power supply of claim 9, wherein after controlling the switching module to be on, the parallel control method for energy storage power supply further comprises:
adjusting the voltage and the phase output by the inverter module in real time according to the synchronizing signal.

11. The parallel control method for energy storage power supply of claim 8, wherein after adjusting the voltage and the phase output by the inverter module to match the synchronizing signal, the parallel control method for energy storage power supply further comprises:
in response to a load of an apparatus electrically connected to the energy storage power supply being less than a preset threshold value, controlling the communication module to be off such that a parallel state of the energy storage power supplies becomes a parallel capacity state.
